(19) United States
(12) Patent Application Publication
(10) Pub. No.: US 2006/0181040 A1
(43) Pub. Date: Aug. 17, 2006

(54) Baby Carriage Non-Roll Safety Brake

(76) Inventors: William Robert Dunney, Buford, GA (US); Theresa Ann Dunney, Buford, GA (US)

Correspondence Address: Mr. William R. Dunney, 4395 Signal Ridge Court, Buford, GA, 30518, US

(21) Appl. No.: 11/059,716

(22) Filed: Feb. 17, 2005

(51) Int. Cl. B62B 7/00

(52) U.S. Cl. 280/47.38

(57) ABSTRACT

The Non-Roll Safety Brake for baby carriages or strollers is the only off the shelf safety brake as an addition that functions by having two synthetic materials that have a coefficient of friction that creates a non skid surface stopping the carriage from rolling. It comes as a complete unit with no assembly required and is designed so that the assembly can be attached to any standard carriage or stroller with only minor tools and does not required any special skills to have the brake function. The spring loaded activator on the handle is engineered to allow the operator of the carriage to activate the brake without using any excessive force since the force to activate the brake comes from the normal usage of the carriage. The assembly, brake pads, and the slide assembly make the Non-Roll Safety Brake a unique product, not available in any other patent.

### PURPOSE AND FUNCTIONALITY

The purpose of the Baby Carriage Non-Roll Safety Brake is to have a safety brake that can be installed on any baby carriage for the purpose of having a locking brake mechanism on the baby carriage. This locking brake mechanism will keep the baby carriage from rolling when it is in the stationery position, or is not being pushed or held by the attendant. This will also provide safety for the baby when the baby is in the carriage and it is not being pushed. This also allows the baby carriage to be used as a bed in which the baby can be at rest and sleeping so that the mother or attendant are do not have to be concerned with the carriage rolling away from them. The Baby Carriage Non-Roll Safety Brake is universal so it can be set up for either a right-handed or a left-handed person, thereby allowing the person who is pushing the carriage to have a hand free to hold another child. Letting the carriage go will automatically lock it in place, eliminating the possibility of a run-away carriage.

The Baby Carriage Non-Roll Safety Brake functions by using the right or left position of the slide handle. When pushing the baby carriage the individual is pushing the slide handle towards the inside of their body which releases the brake from the wheels. Upon release of the brakes by the spring loaded slide lever on the handle of the baby carriage, both of the wheels are released simultaneously and the baby carriage is free to roll forward. Anytime the spring loaded slide is disengaged as the baby carriage is being pushed, both of the wheels will lock up stopping the baby carriage from any further rolling.

### ASSEMBLING THE BABY CARRIAGE NON-ROLL SAFETY BRAKE

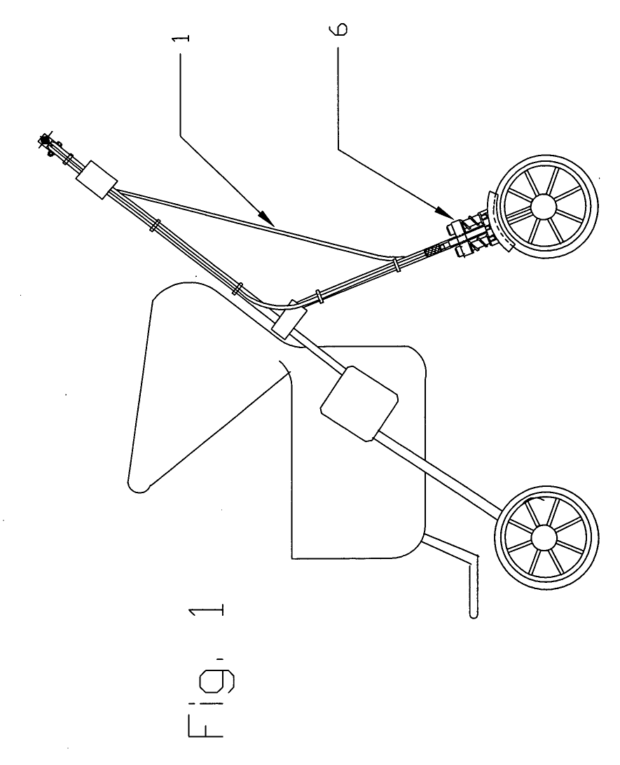

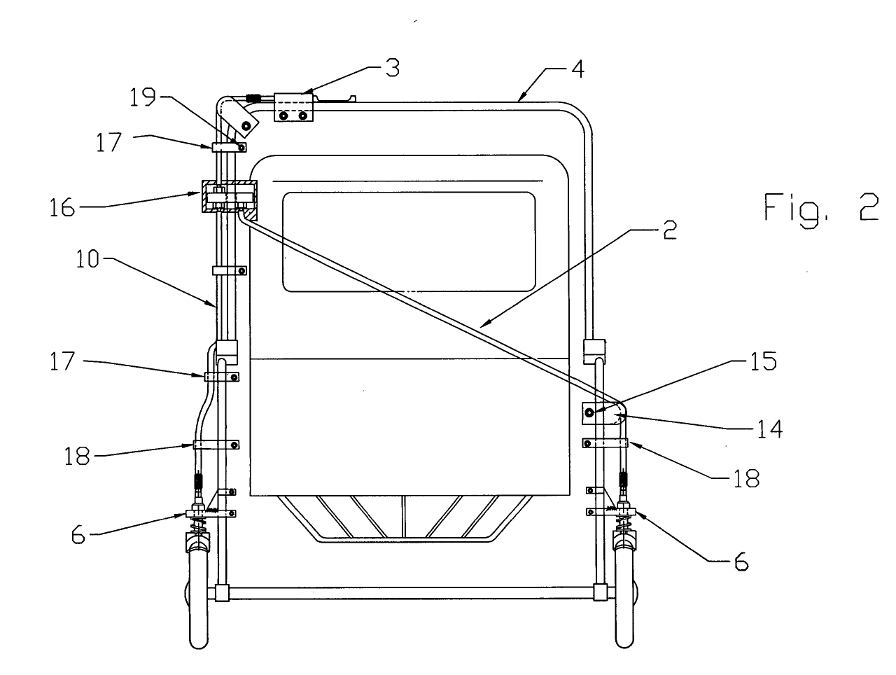

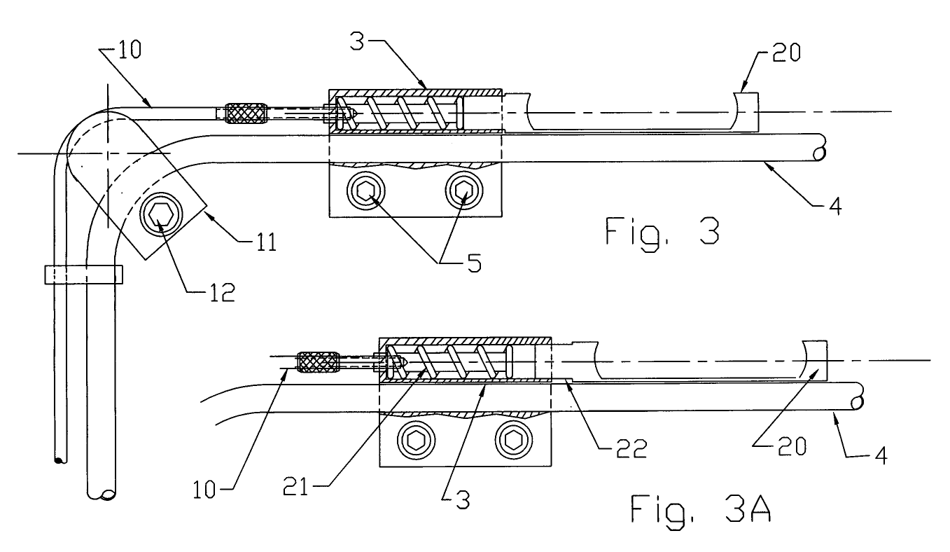

The individual would first decide if the unit was to operate as a left or right hand unit. (FIG. 1, Item 1 & FIG. 2, Item 2) illustrates the Safety Brake as a left-hand unit, leaving the right hand free to hold another child, and shows the Brake Cable in a position that is not a hindrance to the individual operating the baby carriage or stroller. The first step in assembling the Safety Brake is to slide the Spring Loaded Slide (FIG. 3, Item 3) over the handle of the carriage (FIG. 3, Item 4). After this is done, and the Spring Loaded Slide is in position, the individual would then insert the two screws (FIG. 3, Item 5) into the Spring Loaded Slide and snug them so that at completion of the installation, the Spring Loaded Slide will be adjusted for proper tension in relation to the Activating Cable (FIG. 3, Item 10). At that time the two screws will need to be tightened.

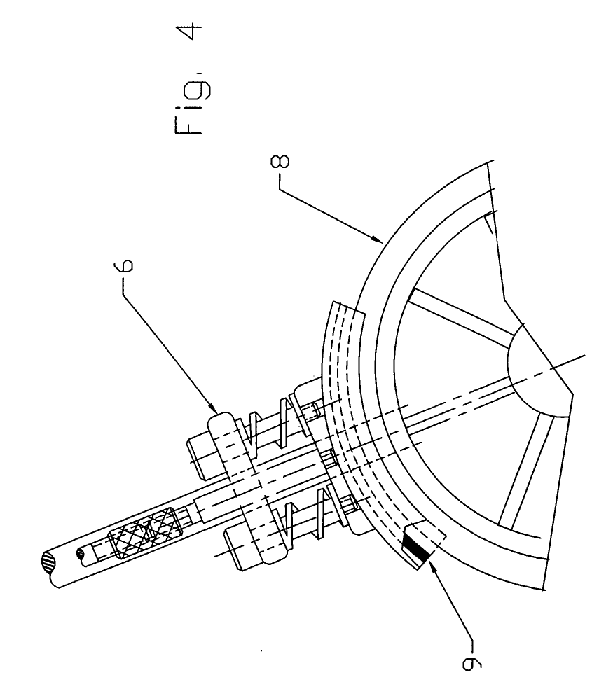

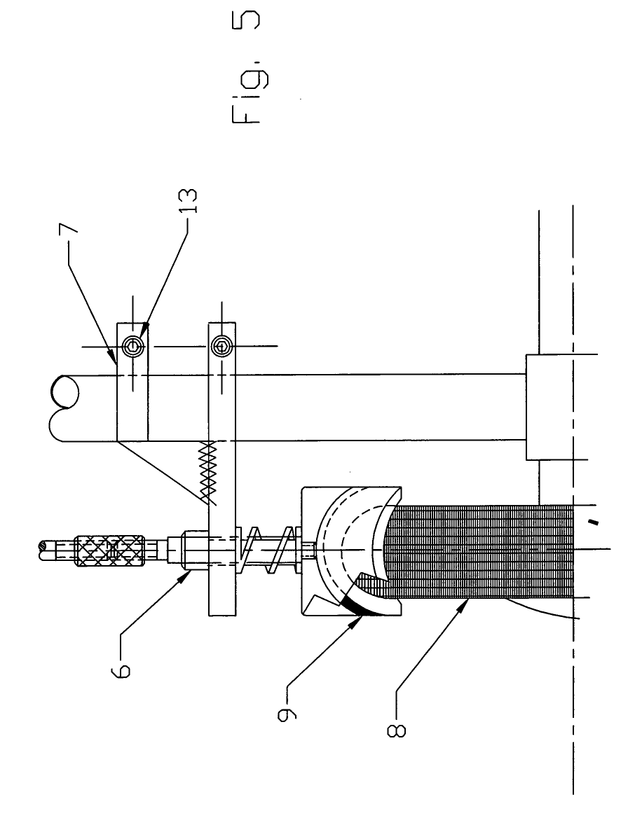

The next step would be to attach the Safety Brake Assembly (FIGS. 1, 2, 4 & 5, Item 6) to the baby carriage on top of the rear wheels. There are two of the Safety Brake Assemblies—one for each of the rear wheels. In attaching the Safety Brake Assembly, the individual would slide the yoke of the unit (FIG. 5, Item 7) over the tubular frame which holds the rear wheel. In doing so, the individual would leave approx. ⅛ of an inch of space between the tire (FIGS. 4 & 5, Item 8) and the Brake Pad (FIGS. 4 & 5, Item 9). Then the two Safety Brake Assembly screws (FIG. 5, Item 13) are inserted and tightened so that the unit will not slip under pressure. Repeat the same procedure for the opposite rear tire.

Now that the Safety Brake Assembly and the Spring Loaded Slide are attached, the next step is to attach the (2) Tension Strains to the handle. First, attach the Tension Strain on the corner of the handle (FIG. 3, Item 11). This is done by sliding it over the corner of the handle and then inserting the screw (FIG. 3, Item 12) into the Tension Strain and tightening the screw so the Tension Strain cannot move when pressure is applied. At this time, the second Tension Strain (FIG. 2, Item 14) is to be installed on the opposite side of the handle as shown in (FIG. 2). After the second Tension Strain has been installed, insert the screw (FIG. 2, Item 15) into the Tension Strain and tighten the screw so that the Tension Strain does not move under pressure.

After the Spring Loaded Slide Assembly is attached, it is important that the Junction Box (FIG. 2, Item 16) is facing the rear of the baby carriage. The Junction Box snaps over the carriage handle and with the tension being applied in both directions from the Activating Cables (FIG. 2, Items 2 & 10), the Junction Box remains in place.

The next step in assembling the Baby Carriage Non-Roll Safety Brake is to attach the Activating Cables (FIGS. 2 & 3, Item 10) to the side of the handle (FIG. 2, Item 4). The first step in the installation process is to in install the (3) Activating Cable Holders (FIG. 2, Item 17) to the sides of the handle. There are (2) other Activating Cable Holders (FIG. 2, Item 18) which are longer and need to be assembled to the bottom of the handles as shown in (FIG. 2). In all (5) of these Activating Cable Holders, it is important that after they have been located the screws (FIG. 2, Item 19) are tightened so that the Cable Holders cannot move when the Activating Cables are engaged to stop the baby carriage from rolling.

Once the installation is completed to this point, the final step is to tighten the Spring Loaded Slide (FIG. 3, Item 3). To perform this final operation, it is important to understand that this is the step that will make the Baby Carriage Non-Roll Safety Brake function properly. It is important to slide the Spring Loaded Slide (FIGS. 2 & 3, Item 3) towards the center of the handle (FIGS. 2 & 3, Item 4). This pulling of the Spring Loaded Slide to the center will take any unnecessary tension off the Activating Cable (FIG. 3A, Item 10). Another important item to notice in sliding the Spring Loaded Slide to the center of the handle is to ensure that the Activating Handle (FIG. 3, Item 20) does not move away from the main body of the Spring Loaded Slide. The (2) screws (FIG. 3, Item 5) are now locked in place and tightened so that the Spring Loaded Slide will not move when the Activating Handle (FIG. 3, Item 20) is moved. With the Baby Carriage Non-Roll Safety Brake now in position and locked in place, the carriage (2) Wheels (FIGS. 4 & 5, Item 8) should be locked and the baby carriage should be in a position that it will not roll on its own.

### OPERATION OF BABY CARRIAGE NON-ROLL SAFETY BRAKE

In operating the Non-Roll Safety Brake on a baby carriage, the individual grabs hold of the Handle (FIGS. 2 & 3, Item 4) inside of the Slide Handle (FIG. 3, Item 20) and slides it towards the center of the baby carriage handle as shown in (FIG. 3A, Item 4). Moving the Slide Handle (FIG. 3A, Item 20) will create a gap of approx. ¼ of an inch (FIG. 3A, Item 22) between the Slide Handle and the body of the Slide Assembly (FIG. 3A, Item 3). This is turn releases the Brake Mechanism (FIGS. 4 & 5, Item 9) from the baby carriage wheels (FIGS. 4 & 5, Item 8), allowing the baby carriage to move freely.

At anytime that the Slide Handle is released (FIGS. 3 & 3A, Item 20), the brake mechanism will engage causing the spring (FIG. 3A, Item 21) to force the Slide Handle (FIG. 3A, Item 20) to move back in the direction of the Slide Assembly (FIG. 3, Item 3). This action of the Slide Assembly will cause the brake pad (FIGS. 4&5, Item 9) to engage the carriage wheels (FIGS. 4&5, Item 8). This action will stop the baby carriage from rolling on a hill or in any position that it may be at risk of moving away from the attendant.

### DESCRIPTION OF THE DRAWINGS

1. FIG. 1: Shows the side view of the Baby Carriage Non-Roll Safety Brake assembled on the baby carriage.

2. FIG. 2: Shows the back view of the baby carriage with the Baby Carriage Non-Roll Safety Brake.

3. FIG. 3: Shows the Slide Mechanism with a cross section indicating how the spring functions. This drawing also shows the cable and how it assembles to the Slide Assembly, how the tension is taken up on the corner of the handle, and shows in detail how the Slide Mechanism is mounted to the handle of the baby carriage being clamped in place by the two bolts.

4. FIG. 3A: Shows the Slide Mechanism with the cross section in the position that it in when the brake is actuated to the wheels of the baby carriage.

5. FIG. 4: Show the side view of the Non-Roll Brake Assembly and how it is positioned in relation to the baby carriage wheels. This drawing also shows the Brake Assembly as it is attached to the baby carriage wheel and frame, and how the springs are attached to activate the unit.

6. FIG. 5: Shows the Non-Roll Brake Assembly from the rear view and how it is positioned in relation to the baby carriage wheels. This drawing also shows how the Brake Assembly is mounted to the tubular strut of the baby carriage, being clamped on by the bolts.

I claim:

1. I claim that the Baby Carriage Non-Roll Safety Brake is the only Safety Brake for baby carriages and strollers that has a Slide Assembly that the individual does not have to squeeze or use excess force or pressure to activate the Safety Brake and uses a spring loaded slip handle which does not need excess pressure to activate or deactivate the carriage brake and uses the natural placement of the hand on the handle to activate or deactivate the carriage brake.

2. I claim that the only Baby Carriage Non-Roll Safety Brake is the only Safety Brake for a stroller or baby carriage that can be manufactured and purchased as an assembled unit and can be attached to any baby carriage or stroller without assembling the unit and that the only Baby Carriage Non-Roll Safety Brake is the only Non Roll Safety Brake for a baby carriage or stroller that can be operated safely with one hand, giving the attendant the ability to guide another child with the other hand or be able to carry something with the other arm without losing control of the carriage.

3. (canceled)

4. I claim that the Baby Carriage Non-Roll Safety Brake is the only Non Roll Baby Carriage Brake that uses a rubber stop that engages the wheels to a stop which uses the principles of engineering by using a rubber pad or brake pad engaged to come in contact under pressure with a rubber or neoprene wheel on the carriage bring in to a stop or stopping it from rolling.
